(19) United States
(12) Patent Application Publication
(10) Pub. No.: US 2007/0154777 A1
(43) Pub. Date: Jul. 5, 2007

(54) Cathode electrodes for direct oxidation fuel cells and systems operating with concentrated liquid fuel at low oxidant stoichiometry

(75) Inventors: Takashi Akiyama, Osaka (JP); Chao-Yang Wang, State College, PA (US)

Correspondence Address: MCDERMOTT WILL & EMERY LLP, 600 13TH STREET, N.W., WASHINGTON, DC, 20005-3096, US

(73) Assignee: MATSUSHITA ELECTRIC INDUSTRIAL CO., LTD. THE PENN STATE RESEARCH FOUNDATION

(21) Appl. No.: 11/325,320

(22) Filed: Jan. 5, 2006

(51) Int. Cl. H01M 4/94; H01M 4/88

(52) U.S. Cl. 429/42; 429/44; 502/101

(57) ABSTRACT

A cathode electrode for use in a fuel cell comprises, in sequence, a catalyst layer, a hydrophobic microporous layer (MPL), and a gas diffusion layer (GDL), wherein the MPL comprises a mixture of first and second hydrophobic materials having different melt viscosities. Also disclosed is a method for fabricating the hydrophobic microporous layer as part of a cathode electrode. The cathode electrode is particularly useful in direct oxidation fuel cells and systems, such as direct methanol fuel cells and systems operating with highly concentrated liquid fuel.

### FIELD OF THE INVENTION

The present disclosure relates generally to fuel cells, fuel cell systems, and electrodes/electrode assemblies for same. More specifically, the present disclosure relates to cathodes for direct oxidation fuel cells (hereinafter “DOFC”), such as direct methanol fuel cells (hereinafter “DMFC”), and their fabrication methods.

### BACKGROUND OF THE DISCLOSURE

A DOFC is an electrochemical device that generates electricity from electrochemical oxidation of a liquid fuel. DOFC's do not require a preliminary fuel processing stage; hence, they offer considerable weight and space advantages over indirect fuel cells, i.e., cells requiring preliminary fuel processing. Liquid fuels of interest for use in DOFC's include methanol, formic acid, dimethyl ether, etc., and their aqueous solutions. The oxidant may be substantially pure oxygen or a dilute stream of oxygen, such as that in air. Significant advantages of employing a DOFC in portable and mobile applications (e.g., notebook computers, mobile phones, personal data assistants, etc.) include easy storage/handling and high energy density of the liquid fuel.

One example of a DOFC system is a DMFC. A DMFC generally employs a membrane-electrode assembly (hereinafter “MEA”) having an anode, a cathode, and a proton-conducting membrane electrolyte positioned therebetween. A typical example of a membrane electrolyte is one composed of a perfluorosulfonic acid—tetrafluorethylene copolymer, such as Nafion® (Nafion® is a registered trademark of E.I. Dupont de Nemours and Company). In a DMFC, a methanol/water solution is directly supplied to the anode as the fuel and air is supplied to the cathode as the oxidant. At the anode, the methanol reacts with the water in the presence of a catalyst, typically a Pt or Ru metal-based catalyst, to produce carbon dioxide, H⁺ions (protons), and electrons. The electrochemical reaction is shown as equation (1) below:
CH₃OH+H₂O→CO₂+6H⁺+6e⁻ (1)

During operation of the DMFC, the protons migrate to the cathode through the proton-conducting membrane electrolyte, which is non-conductive to electrons. The electrons travel to the cathode through an external circuit for delivery of electrical power to a load device. At the cathode, the protons, electrons, and oxygen molecules, typically derived from air, are combined to form water. The electrochemical reaction is given in equation (2) below:
3/20₂+6H⁺+6e^{-→}3H₂O (2)

Electrochemical reactions (1) and (2) form an overall cell reaction as shown in equation (3) below:
CH₃OH+3/20₂→CO₂+2H₂O (3)

One drawback of a conventional DMFC is that the methanol partly permeates the membrane electrolyte from the anode to the cathode, such permeated methanol being termed “crossover methanol”. The crossover methanol chemically (i.e., not electrochemically) reacts with oxygen at the cathode, causing a reduction in fuel utilization efficiency and cathode potential, with a corresponding reduction in power generation of the fuel cell. It is thus conventional for DMFC systems to use excessively dilute (3-6% by vol.) methanol solutions for the anode reaction in order to limit methanol crossover and its detrimental consequences. However, the problem with such a DMFC system is that it requires a significant amount of water to be carried in a portable system, thus diminishing the system energy density.

The ability to use highly concentrated fuel is desirable for portable power sources, particularly since DMFC technology is currently competing with advanced batteries, such as those based upon lithium-ion technology. However, even if the fuel cartridge with highly concentrated fuel (e.g., pure or “neat” methanol) carries little to no water, the anodic reaction, i.e., equation (1), still requires one water molecule for each methanol molecule for complete electro-oxidation. Simultaneously, water is produced at the cathode via reduction of oxygen, i.e., equation (2). Therefore, in order to take full advantage of a fuel cell employing highly concentrated fuel, it would be desirable to: (a) maintain a net water balance in the cell where the total water loss from the cell (mainly through the cathode) preferably does not exceed the net production of water (i.e., two water molecules per each methanol molecule consumed according to equation (3)), and (b) transport some of the produced water from the cathode to anode.

Two approaches have been developed to meet the above-mentioned goals in order to directly use concentrated fuel. A first approach is an active water condensing and pumping system to recover cathode water vapor and return it to the anode (U.S. Pat. No. 5,599,638). While this method achieves the goal of carrying concentrated (and even neat) methanol in the fuel cartridge, it suffers from a significant increase in system volume and parasitic power loss due to the need for a bulky condenser and its cooling/pumping accessories.

The second approach is a passive water return technique in which hydraulic pressure at the cathode is generated by including a highly hydrophobic microporous layer (hereinafter “MPL”) in the cathode, and this pressure is utilized for driving water from the cathode to the anode through a thin membrane (Ren et al. and Pasaogullari & Wang, J Electrochem. Soc., pp A399-A406, March 2004). While this passive approach is efficient and does not incur parasitic power loss, the amount of water returned, and hence the concentration of methanol fuel, depends strongly on the cell temperature and power density. Presently, direct use of neat methanol is demonstrated only at or below 40° C. and at low power density (less than 30 mW/cm ²). Considerably less concentrated methanol fuel is utilized in high power density (e.g., 60 mW/cm²) systems at elevated temperatures, such as 60° C. In addition, the requirement for thin membranes in this method sacrifices fuel efficiency and operating cell voltage, thus resulting in lower total energy efficiency.

In order to utilize highly concentrated fuel with DOFC systems, such as DMFC systems described above, it is necessary to reduce the oxidant stoichiometry ratio, i.e., flow of oxidant (air) to the cathode for reaction according to equation (2) above. In turn, operation of the cathode must be optimized so that liquid product(s), e.g., water, formed on or in the vicinity of the cathode can be removed therefrom without resulting in substantial flooding of the cathode.

Accordingly, there is a prevailing need for DOFC/DMFC systems that maintain a balance of water in the fuel cell and return a sufficient amount of water from the cathode to the anode when operated with highly concentrated fuel and low oxidant stoichiometry ratio, i.e., less than about 8. There is an additional need for DOFC/DMFC systems that operate with highly concentrated fuel, including neat methanol, and minimize the need for external water supplies or condensation of electrochemically produced water.

In view of the foregoing, there exists a need for improved DOFC/DMFC systems and methodologies, including electrodes and electrode assemblies, which facilitate operation of such systems for obtaining optimal performance with very highly concentrated fuel and high power efficiency.

### SUMMARY OF THE DISCLOSURE

An advantage of the present disclosure is improved cathode electrodes for use in fuel cells.

Another advantage of the present disclosure is improved cathode electrodes for use in direct oxidation fuel cells (DOFC's) and DOFC systems, such as direct methanol fuel cells (DMFC's) and systems.

Another advantage of the present disclosure is improved cathode electrodes for use in DOFCs operating with concentrated liquid fuel at low oxidant stoichiometry.

Another advantage of the present disclosure is improved methods of fabricating cathode electrodes for use as part of membrane electrode assemblies of DOFC's and DOFC systems, such as direct methanol fuel cells and systems.

Additional advantages and features of the present disclosure will be set forth in the disclosure which follows and in part will become apparent to those having ordinary skill in the art upon examination of the following or may be learned from the practice of the present disclosure. The advantages may be realized and obtained as particularly pointed out in the appended claims.

According to an aspect of the present disclosure, the foregoing and other advantages are achieved in part by an improved cathode electrode for use in a fuel cell, comprising, in sequence:

(a) a catalyst layer;

(b) a hydrophobic MPL; and

(c) a gas diffusion layer (hereinafter “GDL”);

wherein the MPL comprises a mixture of first and second hydrophobic materials.

According to embodiments of the present disclosure, each of the first and second hydrophobic materials comprises a fluoropolymer; and the melting point and melt viscosity of the first fluoropolymer are greater than the melting point and melt viscosity of the second fluoropolymer.

Embodiments of the present disclosure include those wherein the first fluoropolymer is polytetrafluoroethylene (hereinafter “PTFE”) and the second fluoropolymer is selected from the group consisting of: tetrafluoroethylene-hexafluoropropylene co-polymer (hereinafter “FEP”), tetrafluoroethylene-alkylvinyl ether co-polymer (hereinafter “PFA”), polychlorotrifluoroethylene (hereinafter “PCTFE”), tetrafluoroethylene-ethylene co-polymer (hereinafter “ETFE”), chlorotrifluoroethylene-ethylene co-polymer (hereinafter “ECTFE”), and polyvinylidene fluoride (hereinafter “PVDF”). Preferably, the first fluoropolymer is PTFE and the second fluoropolymer is FEP.

Further embodiments of the present disclosure include those wherein the first hydrophobic material comprises a graphite fluoride and the second hydrophobic material comprises a fluoropolymer. The graphite fluoride can be either electrically non-conductive or electrically conductive. Alternatively, the graphite fluoride can be a mixture of electrically conductive graphite fluoride and an electrically non-conductive graphite fluoride. Preferably, the fluoropolymer comprises PTFE and the MPL further comprises an electrically conductive carbon powder.

Another aspect of the present disclosure is an improved method of fabricating a hydrophobic MPL as part of a cathode electrode for a fuel cell, comprising steps of:

(a) forming a first dispersion comprising an electrically conductive carbon powder dispersed in an aqueous or alcoholic solvent containing a surfactant;

(b) forming a second dispersion comprising first and second hydrophobic materials dispersed in an aqueous or alcoholic solvent, the first hydrophobic material comprising a fluoropolymer;

(c) combining the first and second dispersions with stirring to form a homogeneous paste;

(d) applying a layer of the paste to the surface of a backing layer of a GDL of the cathode; and

(e) drying and heating the paste at an elevated temperature sufficient to substantially remove the surfactant and melt and spread the first hydrophobic material over the surface of the backing layer.

According to embodiments of the present disclosure, the second hydrophobic material is a fluoropolymer, the melting point and melt viscosity of the first fluoropolymer being greater than the melting point and melt viscosity of the second fluoropolymer.

In accordance with embodiments of the present disclosure, the first fluoropolymer is PTFE and the second fluoropolymer is selected from the group consisting of: FEP, PFA, PCTFE, ETFE, ECTFE, and PVDF. Preferably, the first fluoropolymer is PTFE and the second fluoropolymer is FEP.

Further embodiments of the present disclosure include those wherein the first hydrophobic material comprises a fluoropolymer (preferably PTFE) and the second hydrophobic material comprises a graphite fluoride. According to certain embodiments, the graphite fluoride is electrically non-conductive; whereas, according to other embodiments, the graphite fluoride is electrically conductive. Alternatively, the graphite fluoride comprises a mixture of electrically conductive graphite fluoride and an electrically non-conductive graphite fluoride.

Additional advantages of the present disclosure will become readily apparent to those skilled in this art from the following detailed description, wherein only the preferred embodiments of the present disclosure are shown and described, simply by way of illustration but not limitation. As will be realized, the disclosure is capable of other and different embodiments, and its several details are capable of modification in various obvious respects, all without departing from the spirit of the present invention. Accordingly, the drawings and description are to be regarded as illustrative in nature, and not as restrictive.

### BRIEF DESCRIPTION OF THE DRAWINGS

The various features and advantages of the present disclosure will become more apparent and facilitated by reference to the accompanying drawings, provided for purposes of illustration only and not to limit the scope of the invention, wherein the same reference numerals are employed throughout for designating like features and the various features are not necessarily drawn to scale but rather are drawn as to best illustrate the pertinent features, wherein:

FIG. 1 is a simplified, schematic illustration of a DOFC system capable of operating with highly concentrated methanol fuel, i.e., a DMFC system; and

FIG. 2 is a schematic, cross-sectional view of a representative configuration of a membrane electrode assembly suitable for use in a fuel cell/fuel cell system such as the DOFC/DMFC system of FIG. 1.

### DETAILED DESCRIPTION OF THE DISCLOSURE

The present disclosure relates to fuel cells and fuel cell systems with high power conversion efficiency, such as DOFC's and DOFC systems operating with highly concentrated fuel, e.g., methanol fueled DMFC's and DMFC systems, and electrodes/electrode assemblies therefor.

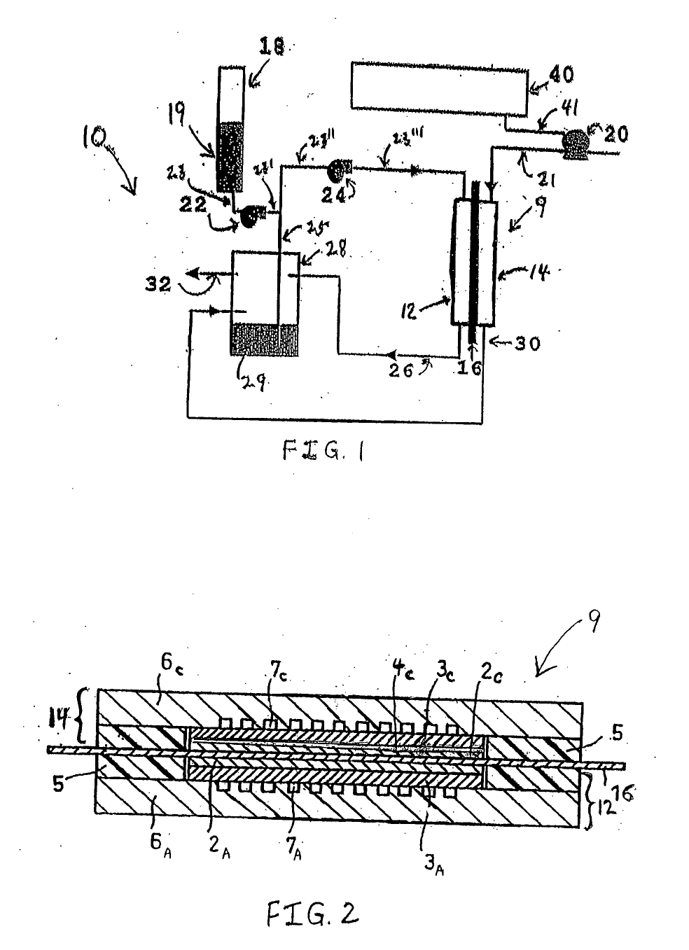

Referring to FIG. 1, schematically shown therein is an illustrative embodiment of a DOFC system adapted for operating with highly concentrated fuel, e.g., a DMFC system 10, which system maintains a balance of water in the fuel cell and returns a sufficient amount of water from the cathode to the anode under high-power and elevated temperature operating conditions. (A DOFC/DMFC system is disclosed in co-pending, commonly assigned U.S. patent application Ser. No. 11/020,306, filed Dec. 27, 2004).

As shown in FIG. 1, DMFC system 10 includes an anode 12, a cathode 14, and a proton-conducting electrolyte membrane 16, forming a multi-layered composite membrane-electrode assembly or structure 9 commonly referred to as an MEA. Typically, a fuel cell system such as DMFC system 10 will have a plurality of such MEA's in the form of a stack; however, FIG. 1 shows only a single MEA 9 for illustrative simplicity. Frequently, the MEA's 9 are separated by bipolar plates that have serpentine channels for supplying and returning fuel and by-products to and from the assemblies (not shown for illustrative convenience). In a fuel cell stack, MEAs and bipolar plates are aligned in alternating layers to form a stack of cells and the ends of the stack are sandwiched with current collector plates and electrical insulation plates, and the entire unit is secured with fastening structures. Also not shown in FIG. 1, for illustrative simplicity, is a load circuit electrically connected to the anode 12 and cathode 14.

A source of fuel, e.g., a fuel container or cartridge 18 containing a highly concentrated fuel 19 (e.g., methanol), is in fluid communication with anode 12 (as explained below). An oxidant, e.g., air supplied by fan 20 and associated conduit 21, is in fluid communication with cathode 14. The highly concentrated fuel from fuel cartridge 18 is fed directly into liquid/gas (hereinafter “L/G”)separator 28 by pump 22 via associated conduit segments 23′ and 25, or directly to anode 12 via pumps 22 and 24 and associated conduit segments 23, 23′, 23″, and 23′″.

In operation, highly concentrated fuel 19 is introduced to the anode side of the MEA 9, or in the case of a cell stack, to an inlet manifold of an anode separator of the stack. Water produced at the cathode 14 side of MEA 9 or cathode cell stack via electrochemical reaction (as expressed by equation (2)) is withdrawn therefrom via cathode outlet or exit port/conduit 30 and supplied to liquid/gas separator 28. Similarly, excess fuel, water, and carbon dioxide gas are withdrawn from the anode side of the MEA 9 or anode cell stack via anode outlet or exit port/conduit 26 and supplied to L/G separator 28. The air or oxygen is introduced to the cathode side of the MEA 9 and regulated to maximize the amount of electrochemically produced water in liquid form while minimizing the amount of electrochemically produced water vapor, thereby minimizing the escape of water vapor from system 10.

During operation of system 10, air is introduced to the cathode 14 (as explained above) and excess air and liquid water are withdrawn therefrom via cathode exit port/conduit 30 and supplied to L/G separator 28. As discussed further below, the input air flow rate or air stoichiometry is controlled to maximize the amount of the liquid phase of the electrochemically produced water while minimizing the amount of the vapor phase of the electrochemically produced water. Control of the oxidant stoichiometry ratio can be obtained by setting the speed of fan 20 at a rate depending on the fuel cell system operating conditions or by an electronic control unit (hereinafter “ECU”) 40, e.g., a digital computer-based controller or equivalently performing structure. ECU 40 receives an input signal from a temperature sensor in contact with the liquid phase 29 of L/G separator 28 (not shown in the drawing for illustrative simplicity) and adjusts the oxidant stoichiometric ratio (via line 41 connected to oxidant supply fan 20) so as to maximize the liquid water phase in the cathode exhaust and minimize the water vapor phase in the exhaust, thereby reducing or obviating the need for a water condenser to condense water vapor produced and exhausted from the cathode of the MEA 2. In addition, ECU 40 can increase the oxidant stoichiometry beyond the minimum setting during cold-start in order to avoid excessive water accumulation in the fuel cell.

Liquid water 29 which accumulates in the L/G separator 28 during operation may be returned to anode 12 via circulating pump 24 and conduit segments 25, 23″, and 23′″. Exhaust carbon dioxide gas is released through port 32 of L/G separator 28.

As indicated above, cathode exhaust water, i.e., water which is electrochemically produced at the cathode during operation, is partitioned into liquid and gas phases, and the relative amounts of water in each phase are controlled mainly by temperature and air flow rate. The amount of liquid water can be maximized and the amount of water vapor minimized by using a sufficiently small oxidant flow rate or oxidant stoichiometry. As a consequence, liquid water from the cathode exhaust can be automatically trapped within the system, i.e., an external condenser is not required, and the liquid water can be combined in sufficient quantity with a highly concentrated fuel, e.g., greater than about 5 molar, for use in performing the anodic electrochemical reaction, thereby maximizing the concentration of fuel and storage capacity and minimizing the overall size of the system. The water can be recovered in any suitable existing type of L/G separator 28, e.g., such as those typically used to separate carbon dioxide gas and aqueous methanol solution.

The DOFC/DMFC system 10 shown in FIG. 1 comprises at least one MEA 9 which includes a polymer electrolyte membrane 16 and a pair of electrodes (an anode 12 and a cathode 14) each composed of a catalyst layer and a gas diffusion layer sandwiching the membrane. Typical polymer electrolyte materials include fluorinated polymers having perfluorosulfonate groups or hydrocarbon polymers such as poly-(arylene ether ether ketone) (hereinafter “PEEK”). The electrolyte membrane can be of any thickness as, for example, between about 25 and about 180 μm. The catalyst layer typically comprises platinum or ruthenium based metals, or alloys thereof. The anodes and cathodes are typically sandwiched by bipolar separator plates having channels to supply fuel to the anode and an oxidant to the cathode. A fuel cell stack can contain a plurality of such MEA's 9 with at least one electrically conductive separator placed between adjacent MEA's to electrically connect the MEA's in series with each other, and to provide mechanical support.

As has been indicated above, ECU 40 can adjust the oxidant flow rate or stoichiometric ratio so as to maximize the liquid water phase in the cathode exhaust and minimize the water vapor phase in the exhaust, thereby eliminating the need for a water condenser. ECU 40 adjusts the oxidant flow rate, and hence the stoichiometric ratio, according to equation (4) given below:

$${ξ}_{c} = \frac{0.42 ( γ + 2 )}{3 {η}_{fuel}} \frac{p}{{p}_{sat}} \qquad ( 4 )$$

wherein ξ_{c} is the oxidant stoichiometry, γ is the ratio of water to fuel in the fuel supply, pₛₐₜ is the water vapor saturation pressure corresponding to the cell temperature, p is the cathode operating pressure, and η_{fuel} is the fuel efficiency, defined as the ratio of the operating current density, I, to the sum of the operating current density and the equivalent fuel (e.g., methanol) crossover current density, Iₓₒᵥₑᵣ as expressed by equation (5) below:

$${η}_{fuel} = \frac{I}{I + {I}_{xover}} \qquad ( 5 )$$

Such controlled oxidant stoichiometry automatically ensures an appropriate water balance in the DMFC (i.e. enough water for the anode reaction) under any operating conditions. For instance, during start-up of a DMFC system, when the cell temperature increases from e.g., 20° C. to the operating point of 60° C., the corresponding Pₛₐₜ is initially low, and hence a large oxidant stoichiometry (flow rate) should be used in order to avoid excessive water accumulation in the system and therefore cell flooding by liquid water. As the cell temperature increases, the oxidant stoichiometry (e.g., air flow rate) can be reduced according to equation (4).

In the above, it is assumed, though not required, that the amount of liquid (e.g., water) produced by electrochemical reaction in MEA 9 and supplied to L/G separator 28 is essentially constant, whereby the amount of liquid product returned to the inlet of anode 12 via pump 24 and conduit segments 25, 23″, and 23′″ is essentially constant, and is mixed with concentrated liquid fuel 19 from fuel container or cartridge 18 in an appropriate ratio for supplying anode 12 with fuel at an ideal concentration.

Referring now to FIG. 2, shown therein is a schematic, cross-sectional view of a representative configuration of a MEA 9 for illustrating its various constituent elements in more detail. As illustrated, a cathode electrode 14 and an anode electrode 12 sandwich a polymer electrolyte membrane 16 made of a material, such as described above, adapted for transporting hydrogen ions from the anode to the cathode during operation. The anode electrode 12 comprises, in order from electrolyte membrane 16, a metal-based catalyst layer 2_{A} in contact therewith, and an overlying GDL 3_{A}, whereas the cathode electrode 14 comprises, in order from electrolyte membrane 16: (1) a metal-based catalyst layer 2_{C} in contact therewith; (2) an intermediate, hydrophobic MPL 4_{C}; and (3) an overlying GDL 3_{C}. Each of the GDLs 3_{A} and 3_{C} is gas permeable and electrically conductive, and may be comprised of a porous carbon-based material including a carbon powder and a fluorinated resin, with a support made of a material such as, for example, carbon paper, woven or non-woven cloth, felt, etc. Metal-based catalyst layers 2_{A} and 2_{C} may, for example, comprise Pt or Ru.

In order to increase the concentration of the fuel stored in fuel cartridge 18, it is preferable that the oxidant stoichiometry ratio (flow rate), ξ_{c}, be reduced to less than about 8, e.g., less than about 2. As a consequence, the cathode electrode must be optimized with respect to liquid product (e.g., water) removal therefrom so as to prevent flooding during operation at such low oxidant stoichiometery ratios (flow rates). This is accomplished by means of hydrophobic MPL 4_{C} interposed between catalyst layer 2_{C} and GDL 3_{C}.

Completing MEA 9 are respective electrically conductive anode and cathode separators 6_{A} and 6_{C} for mechanically securing the anode 12 and cathode 14 electrodes against polymer electrolyte membrane 16. As illustrated, each of the anode and cathode separators 6_{A} and 6_{C} includes respective channels 7_{A} and 7_{C} for supplying reactants to the anode and cathode electrodes and for removing excess reactants and liquid and gaseous products formed by the electrochemical reactions. Lastly, MEA 9 is provided with gaskets 5 around the edges of the cathode and anode electrodes for preventing leaking of fuel and oxidant to the exterior of the assembly. Gaskets 5 are typically made of an O-ring, a rubber sheet, or a composite sheet comprised of elastomeric and rigid polymer materials.

Desirable characteristics of hydrophobic MPL 4_{C} for ensuring adequate removal of liquid product (e.g., water in the case of DMFC cells) from the cathode electrode of MEA 9 in order to minimize flooding during operation at low oxidant stoichiometery ratios (flow rates) include:

1. sufficient electrical conductivity;

2. highly hydrophobic characteristics for water repellency; and

3. sufficient porosity for good gas permeability.

Typically, MPL 4_{C} is optimized for liquid product (water) removal by use of a composite material formed of a carbon black and PTFE, with a layer thickness of about 25-50 μm and an average pore size between 10 and 500 nm. The carbon black (e.g., Vulcan XC72R) provides the composite material with electrical conductivity and porous structure, and the PTFE provides the composite material with highly hydrophobic characteristics.

However, further improvement/optimization of MPL 4_{C} for enhancing its hydrophobic characteristic and facilitating use of additional materials in its fabrication is considered advantageous in obtaining increased flexibility/ease of electrode manufacture and improved system operation at low oxidant stoichiometry ratios.

A typical sequence of steps utilized for fabricating the above-described MPL 4_{C} formed of carbon black-PTFE composite material is as follows:

1. a carbon black powder is dispersed in water or an alcoholic solvent along with a surfactant to form a first dispersion;

2. a PTFE powder is dispersed in the water or an alcoholic solvent to form a second dispersion;

3. the first and second dispersions are combined with stirring to form a homogeneously mixed paste;

4. the paste is applied to the GDL 3_{C} backing layer (e.g., carbon cloth or paper); and

5. the GDL 3_{C} with the paste applied thereto is dried and heated to remove the surfactant therefrom and melt and spread the PTFE over the surface of the backing layer to form the MPL 4_{C}.

However, whereas PTFE is a very hydrophobic fluoropolymer, it also has a very high melting point (327° C.) and melt viscosity (10 GPa·sec. at 380° C.), and consequently disadvantageously requires a very high melting temperature while exhibiting very little spreading.

According to embodiments of the present disclosure, therefore, other fluoropolymers which exhibit lower viscosities at their melting points (e.g., 1 to 10 GPa·sec. at less than about 350° C.) are substituted for part of the PTFE in the above procedure for use as the hydrophobic component of GDL 3_{C}. Examples of suitable fluoropolymers, along with their respective approximate melting points (MP), are given below:

1. FEP: 260-270° C.;

2. PFA: 300-310° C.;

3. PCTFE: 220° C.;

4. ETFE: 270° C.;

5. ECTFE: 245° C.; and

6. PVDF: MP 172-175° C.

According to these embodiments of the disclosure, a portion of the PTFE utilized in the above-described procedure is substituted with at least one of the enumerated lower viscosity fluoropolymers because the latter, when used alone, spread too readily over the GDL support in step 5, thereby clogging the pores formed by or in the carbon black powder or cloth, disadvantageously reducing the gas/fuel permeability through the MPL. Therefore, steps 2-3 of the above sequence are modified according to embodiments of the present disclosure to include a blend, or mixture, of a high melt viscosity fluoropolymer (e.g., PTFE) and at least one lower melt viscosity fluorocarbon polymer (e.g., one or more of fluoropolymers 1-6 enumerated above).

A preferred blend of fluoropolymers is FEP-PTFE, in view of FEP having a very high hydrophobicity comparable to that of PTFE. As a consequence, replacement of a portion of the PTFE with FEP does not result in any diminution of hydrophobicity of the MPL formed therefrom.

According to other embodiments of the present disclosure, graphite fluoride is utilized as the hydrophobic material for MPL 4_{C} in view of its extremely high hydrophobicity. For example, the contact angle of graphite fluoride with water is 140°, whereas the contact angle of PTFE with water is only 100°. However, graphite fluoride is a powder made by treatment of carbon black or graphite with fluorine gas and is difficult to be fabricated into MPL 4_{C} by itself. In addition, it is not electrically conductive.

In accordance with embodiments of the present disclosure, therefore, steps 2-3 of the above sequence are modified to form a paste comprised of graphite fluoride, electrically conductive carbon black, and a hydrophobic polymer (e.g., PTFE) as a binder. Preferably the paste comprises more than about 10 wt. % carbon black for maintaining good electrical conductivity of the resultant MPL 4_{C}, as well as more than about 10 wt. % of the hydrophobic polymer.

According to yet other embodiments of the present disclosure, an electrically conductive graphite fluoride powder is utilized for forming MPL 4_{C}. In this regard, it is noted that stoichiometric graphite fluoride having a 1:1 atomic ratio of fluorine to carbon (F:C) is not electrically conductive; however, graphite fluoride having a F:C ratio less than about 1 is electrically conductive, with the conductivity increasing as the F:C ratio decreases.

In accordance with further embodiments of the present disclosure, therefore, steps 2-3 of the above sequence are modified to form a paste comprised of electrically conductive graphite fluoride, electrically conductive carbon black, and a hydrophobic polymer (e.g., PTFE) as a binder.

Alternatively, according to still further embodiments of the present invention, steps 2-3 of the above sequence are modified to form a paste comprised of electrically conductive and non-conductive graphite fluoride, electrically conductive carbon black, and a hydrophobic polymer (e.g., PTFE) as a binder.

In summary, the present disclosure offers a number of advantages in fabrication and performance of DOFC's/DMFC's and DOFC/DMFC systems, including enabling greater flexibility and ease in fabrication of MEA's for use in such systems with cathode electrodes comprising improved MPL's having increased hydrophobicity facilitating operation with conservation/recycling of liquid (e.g., water) product at low oxidant stoichiometries (flow rates).

In the previous description, numerous specific details are set forth, such as specific materials, structures, reactants, processes, etc., in order to provide a better understanding of the present disclosure. However, the present disclosure can be practiced without resorting to the details specifically set forth. In other instances, well-known processing materials and techniques have not been described in detail in order not to unnecessarily obscure the present disclosure.

Only the preferred embodiments of the present disclosure and but a few examples of its versatility are shown and described in the present disclosure. It is to be understood that the present disclosure is capable of use in various other combinations and environments and is susceptible of changes and/or modifications within the scope of the inventive concept as expressed herein.

What is claimed is:

1. A cathode electrode for use in a fuel cell, comprising, in sequence:
(a) a catalyst layer;
(b) a hydrophobic microporous layer (MPL); and
(c) a gas diffusion layer (GDL);
wherein said MPL comprises a mixture of first and second hydrophobic materials.

2. The cathode as in claim 1, wherein:
each of said first and second hydrophobic materials comprises a fluoropolymer.

3. The cathode as in claim 2, wherein:
the melting point and melt viscosity of said first fluoropolymer are greater than the melting point and melt viscosity of said second fluoropolymer.

4. The cathode as in claim 3, wherein:
said first fluoropolymer is PTFE and said second fluoropolymer is selected from the group consisting of: tetrafluoroethylene-hexafluoropropylene co-polymer (FEP), tetrafluoroethylene-alkylvinyl ether co-polymer (PFA), polychlorotrifluoroethylene (PCTFE), tetrafluoroethylene-ethylene co-polymer (ETFE), chlorotrifluoroethylene-ethylene co-polymer (ECTFE), and polyvinylidene fluoride (PVDF).

5. The cathode as in claim 3, wherein:
said first fluoropolymer is PTFE and said second fluoropolymer is FEP.

6. The cathode as in claim 1, wherein:
said first hydrophobic material comprises a graphite fluoride and said second hydrophobic material comprises a fluoropolymer.

7. The cathode as in claim 6, wherein:
said graphite fluoride is electrically non-conductive.

8. The cathode as in claim 6, wherein:
said graphite fluoride is electrically conductive.

9. The cathode as in claim 6, wherein:
said graphite fluoride comprises a mixture of electrically conductive graphite fluoride and an electrically non-conductive graphite fluoride.

10. The cathode as in claim 6, wherein:
said fluoropolymer comprises polytetrafluoroethylene PTFE.

11. The cathode as in claim 1, wherein:
said MPL further comprises an electrically conductive carbon powder.

12. A method of fabricating a hydrophobic microporous layer (MPL) as part of a cathode electrode of a fuel cell, comprising steps of:
(a) forming a first dispersion comprising an electrically conductive carbon powder dispersed in an aqueous or alcoholic solvent containing a surfactant;
(b) forming a second dispersion comprising first and second hydrophobic materials dispersed in an aqueous or alcoholic solvent, said first hydrophobic material comprising a fluoropolymer;
(c) combining said first and second dispersions with stirring to form a homogeneous paste;
(d) applying a layer of said paste to the surface of a backing layer of a gas diffusion layer (GDL) of said cathode; and
(e) drying and heating said paste at an elevated temperature sufficient to substantially remove said surfactant and melt and spread said first hydrophobic material over said surface of said backing layer.

13. The method according to claim 12, wherein:
said second hydrophobic material is a fluoropolymer, the melting point and melt viscosity of said first fluoropolymer being greater than the melting point and melt viscosity of said second fluoropolymer.

14. The method according to claim 13, wherein:
said first fluoropolymer is polytetrafluoroethylene (PTFE) and said second fluoropolymer is selected from the group consisting of: tetrafluoroethylene-hexafluoropropylene co-polymer (FEP), tetrafluoroethylene-alkylvinyl ether co-polymer (PFA), polychlorotrifluoroethylene (PCTFE), tetrafluoroethylene-ethylene co-polymer (ETFE), chlorotrifluoroethylene-ethylene co-polymer (ECTFE), and polyvinylidene fluoride (PVDF).

15. The method according to claim 13, wherein:
said first fluoropolymer is PTFE and said second fluoropolymer is FEP.

16. The method according to claim 12, wherein:
said first hydrophobic material comprises a fluoropolymer and said second hydrophobic material comprises a graphite fluoride.

17. The method according to claim 16, wherein: said graphite fluoride is electrically non-conductive.

18. The method according to claim 16, wherein: said graphite fluoride is electrically conductive.

19. The method according to claim 16, wherein: said graphite fluoride comprises a mixture of electrically conductive graphite fluoride and an electrically non-conductive graphite fluoride.

20. The method according to claim 16, wherein: said fluoropolymer comprises PTFE.
